(19) United States
(12) Patent Application Publication
(10) Pub. No.: US 2026/0084287 A1
(43) Pub. Date: Mar. 26, 2026

(54) ELECTRONIC DEVICE, CONTROL METHOD, AND RECORDING MEDIUM

(71) Applicant: CASIO COMPUTER CO., LTD., Tokyo (JP)

(72) Inventor: Takeo ISHIZU, Tokyo (JP)

(73) Assignee: CASIO COMPUTER CO., LTD., Tokyo (JP)

(21) Appl. No.: 19/262,166

(22) Filed: Jul. 8, 2025

(30) Foreign Application Priority Data
Sep. 24, 2024 (JP) 2024-164885

(51) Int. Cl. B25J 9/00; B25J 19/02; H02J 50/00

(52) U.S. Cl. CPC B25J 9/0009; B25J 9/0003; B25J 19/027; H02J 50/00

(57) ABSTRACT

An electronic device includes an actuation member that actuates movable portion, a sensor that detects placement of the electronic device in a power-receivable position that is a position where power supplied from a power supply is receivable, and at least one processor that controls the actuation member such that a predetermined motion is performed due to the activation of the movable portion. In response to not detecting by the sensor the placement of the electronic device in the power-receivable position, the at least one processor controls the actuation member such that a first motion is performed as the predetermined motion. In response to detecting by the sensor the placement of the electronic device in the power-receivable position, the at least one processor controls, the actuation member such that the first motion is not performed as the predetermined motion.

### CROSS-REFERENCE TO RELATED APPLICATIONS

This application is based upon and claims the benefit of priority under 35 USC 119 of Japanese Patent Application No. 2024-164885, filed on Sep. 24, 2024, the entire disclosure of which, including the description, claims, drawings, and abstract, is incorporated herein by reference in its entirety.

### FIELD OF THE INVENTION

The present disclosure relates generally to an electronic device, a control method, and a recording medium.

### BACKGROUND OF THE INVENTION

In recent years, robots are known that are developed to serve a pet-like role capable of communicating with a user. Such a robot is disclosed in, for example, International Publication No. WO 2020/129992. The robot disclosed in International Publication No. 2020/129992 identifies a position of a light source included in a charging station and moves on its own to the charging station for charging of a secondary battery.

### SUMMARY OF THE INVENTION

An electronic device according to an aspect of the present disclosure includes an actuation member that actuates movable portion, a sensor that detects placement of the electronic device in a power-receivable position that is a position where power supplied from a power supply is receivable, and at least one processor that controls the actuation member such that a predetermined motion is performed due to the activation of the movable portion. The at least one processor controls, in response to not detecting by the sensor the placement of the electronic device in the power-receivable position, the actuation member such that a first motion is performed as the predetermined motion, and controls, in response to detecting by the sensor the placement of the electronic device in the power-receivable position, the actuation member such that the first motion is not performed as the predetermined motion.

### BRIEF DESCRIPTION OF DRAWINGS

A more complete understanding of this application can be obtained when the following detailed description is considered in conjunction with the following drawings, in which:

FIG. 1 is a perspective view of an electronic device and a power supply according to Embodiment 1;

FIG. 2 is a perspective view of a main body of the electronic device according to Embodiment 1;

FIG. 3 is a cross-sectional view of the electronic device and the power supply according to Embodiment 1;

FIG. 4 illustrates configuration of a power transmission system according to Embodiment 1;

FIG. 5 is a diagram for explanation of each motion performed by the electronic device according to Embodiment 1;

FIG. 6A is a diagram for explanation of a first breathing motion performed by the electronic device according to embodiment 1;

FIG. 6B is a diagram for explanation of a second breathing motion performed by the electronic device according to Embodiment 1;

FIG. 7 is a flowchart of device control processing executed by the electronic device according to Embodiment 1; and

FIG. 8 illustrates configuration of a power transmission system according to Embodiment 2.

### DETAILED DESCRIPTION OF THE INVENTION

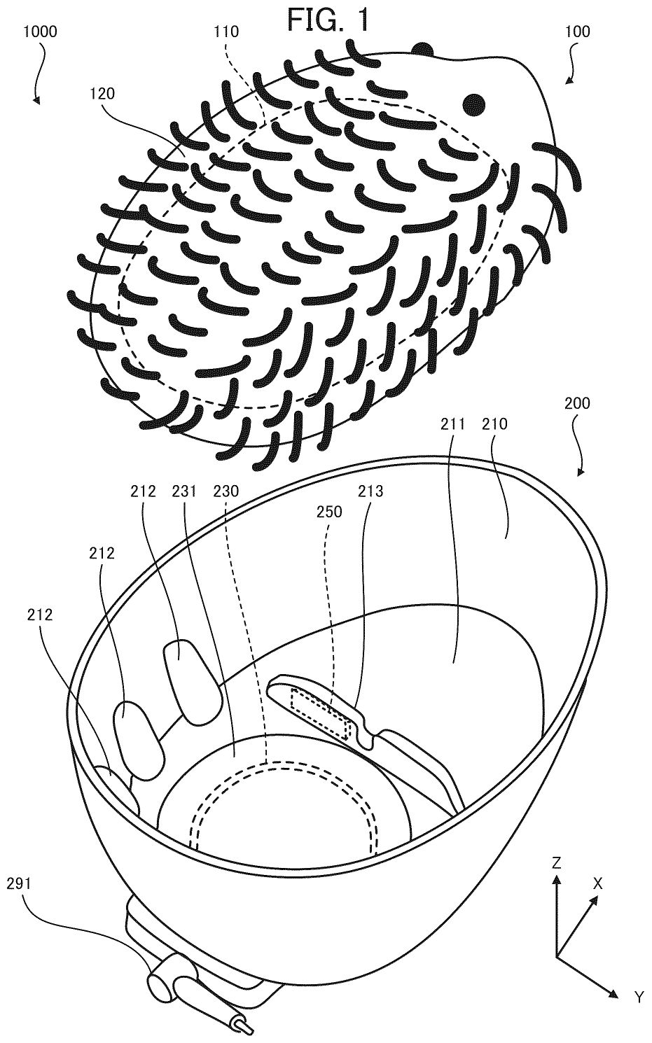

Embodiments of the present disclosure are described below in detail with reference to the drawings. In the drawings, the same or corresponding components are assigned the same reference sign. A power transmission system 1000 according to Embodiment 1 that is illustrated in FIG. 1 is a system in which a power supply 200 wirelessly supplies power to an electronic device 100. The power supply 200 wirelessly supplies power to the electronic device 100 in response to the electronic device 100 being housed in a housing 210 of the power supply 200. The term “wirelessly” herein means that there are no cable connections, electrode contacts, or the like.

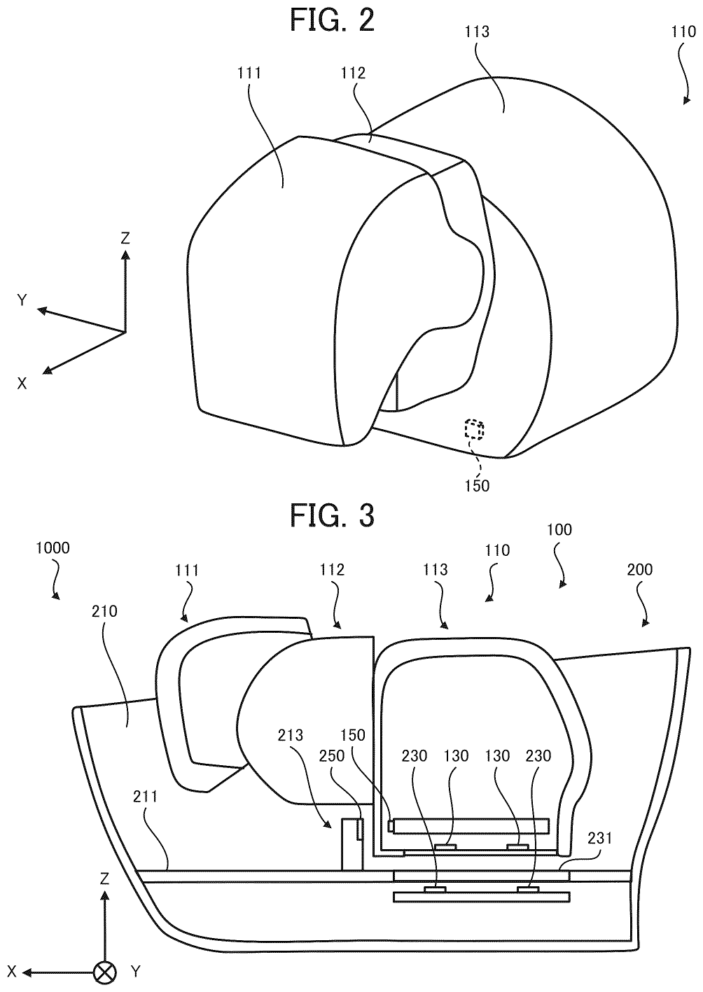

The electronic device 100 is a device that operates on the power stored in a built-in battery in the electronic device 100. The electronic device 100 charges the built-in battery with the power supplied by the power supply 200. In the present embodiment, the electronic device 100 is a robot that operates autonomously without direct operation by a user. More specifically, the electronic device 100 is a pet robot designed to resemble and simulate a small animal. The electronic device 100 includes a main body 110 and an exterior 120. The main body 110 contains various components necessary for operation of the electronic device 100. As illustrated in FIG. 2, the main body 110 includes a head portion 111, a joint 112, and a body portion 113. The head portion 111 corresponds to the head of a small animal. The joint 112 connects the head portion 111 and the body portion 113 rotatably. The body portion 113 corresponds to the body of a small animal. The exterior 120 covers the main body 110. The exterior 120 includes decorative components resembling eyes, and fluffy fur. The surface material of the exterior 120 is, for example, made of an artificial pile fabric designed to simulate a small animal's fur, to simulate the feel of a small animal. The lining of the exterior 120 is made of, for example, fibers, leather, rubber, or the like. Since the exterior 120 is made of a flexible material, the exterior 120 can follow movement of the main body 110.

The electronic device 100 may be stored in the housing 210 either automatically or manually. For example, the electronic device 100 may automatically move into the housing 210 in response to the remaining battery level falling below a reference value. As another example, the user may cause the electronic device 100 to be housed in the housing 210 in accordance with a notification from the electronic device 100. This notification indicates that the remaining battery level is low and is issued by the electronic device 100 in response to the remaining battery level falling below the reference value.

FIG. 3 schematically illustrates a cross-section of the electronic device 100 and the power supply 200 in a “housed state” cut along a plane extending in the longitudinal and vertical directions of the housing 210. In FIG. 3, for ease of understanding, the electronic device 100 is illustrated with the exterior 120 omitted, and only the main body 110 is illustrated. Additionally, in FIG. 3, for ease of understanding, the hatching on the cross-section is omitted. A power receiving coil 130 and a magnetic sensor 150 are disposed inside the body portion 113. As illustrated in FIG. 3, housing the electronic device 100 in the housing 210 causes the magnetic sensor 150 and a magnet 250 to be close to each other, allowing the magnetic sensor 150 to detect the magnetism generated by the magnet 250. Furthermore, as a result of housing the electronic device 100 in the housing 210, a power transmission coil 230 and the power receiving coil 130 are caused to be close and face each other, enabling power to be supplied from the power supply 200 to the electronic device 100.

The power supply 200 functions as a charging station to charge the battery included in the electronic device 100. The power supply 200 receives power from an alternating current (AC) adapter equipped with a direct current (DC) plug 291. The power supply 200 includes the housing 210 for housing the electronic device 100. The housing 210 is shaped to resemble a small animal house and has a bowl-like shape, more specifically, has a shape that resembles an egg split in half along a plane that includes the central axis extending in the longitudinal direction. A bottom plate 211 for mounting the electronic device 100 is disposed at the bottom of the housing 210. A coil cover 231 is embedded in the bottom plate 211 such that an upper surface of the bottom plate 211 and an upper surface of the coil cover 231 are in the same plane. The electronic device 100 is to be placed on the bottom plate 211 in which the coil cover 231 is embedded. The coil cover 231 is a member that protects the power transmission coil 230 and has a disc shape.

Multiple protrusions 212 are disposed inside a side wall of the housing 210. The protrusions 212 are members to restrict movement of the electronic device 100 in the horizontal direction in a state in which the electronic device 100 is housed in the housing 210 and thus power can be supplied to the electronic device 100 (hereinafter referred to as a “housed state” as appropriate). The bottom plate 211 has a protrusion 213 at a center thereof. The protrusion 213 is a member to restrict movement of the electronic device 100 in the longitudinal direction of the housing 210 in the housed state. The protrusion 213 has a shape extending in the width direction of the housing 210. The protrusions 212 and the protrusion 213 are preferably arranged such that movement of the electronic device 100 is not excessively restricted, that is, so as to allow for some movement of the electronic device 100. With this configuration, for example, a motion simulating a breathing motion by the electronic device 100 designed to resemble and simulate a small animal within the housing 210 resembling a small animal house is not prevented. The magnet 250 is provided inside the protrusion 213. Upon the electronic device 100 being housed in the housing 210 and the electronic device 100 detecting the magnetism generated by the magnet 250, supply of power from by the power supply 200 to the electronic device 100 is started.

In the present embodiment, the axis extending in the vertical direction is the Z-axis, the axis extending in a direction orthogonal to the Z-axis is the X-axis, and the axis extending in a direction orthogonal to both the Z-axis and the X-axis is the Y-axis. In the present embodiment, the power supply 200 is arranged such that the direction extending from the rear end to the front end of the housing 210 in the longitudinal direction is the positive direction of the X-axis. The front end in the longitudinal direction of the housing 210 is the more pointed end among both ends in the longitudinal direction of the housing 210.

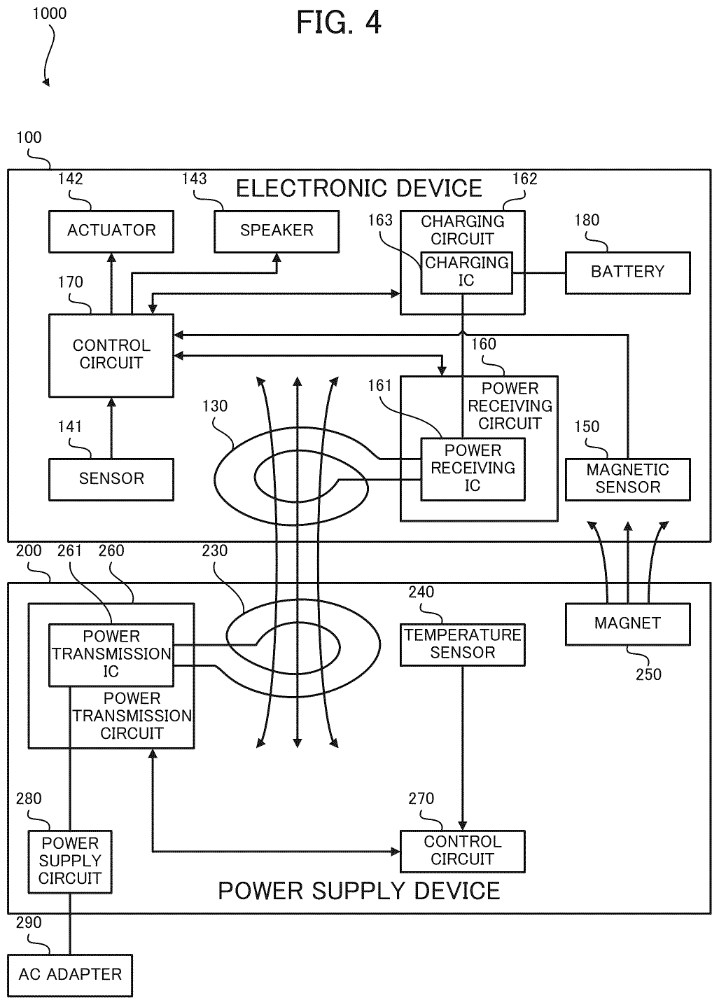

The power transmission system 1000 illustrated in FIG. 4 includes the electronic device 100 and the power supply 200. The electronic device 100 includes the power receiving coil 130, a sensor 141, an actuator 142, a speaker 143, the magnetic sensor 150, a power receiving circuit 160, a charging circuit 162, a control circuit 170, and a battery 180. The power supply 200 includes the power transmission coil 230, a temperature sensor 240, the magnet 250, a power transmission circuit 260, a control circuit 270, and a power supply circuit 280. The power receiving coil 130 is a coil that is to couple with the power transmission coil 230 and receives power wirelessly. The power receiving coil 130 induces an electromotive force in accordance with changes in the magnetic flux induced by the power transmission coil 230. The power receiving coil 130 is a wire wound around an axis extending in the Z-axis direction.

The sensor 141 is a sensor for detecting various physical quantities. Examples of the sensor 141 include a touch sensor, an acceleration sensor, an angular velocity sensor, a sound sensor, an illuminance sensor, and a temperature sensor. The touch sensor, for example, detects that the user touches the exterior 120. The acceleration sensor, for example, detects acceleration applied to the entire or part of the electronic device 100. The angular velocity sensor, for example, detects an angular velocity of the entire or part of the electronic device 100. The sound sensor, for example, detects a sound emitted by the user. The illuminance sensor, for example, detects illuminance around the electronic device 100. The temperature sensor, for example, detects internal or external temperature of the electronic device 100. The sensor 141 supplies to the control circuit 170 an electrical signal indicating a result of the detection.

The actuator 142 is a mechanism for operating each component of the electronic device 100. The actuator 142 operates in accordance with the control by the control circuit 170. For example, the actuator 142 is a mechanism for moving the electronic device 100 forward and backward and for rotating the head portion 111 relative to the body portion 113. In the present embodiment, the actuator 142 has a mechanism for rotating the head portion 111 around a rotation axis extending in the Y-axis direction and a mechanism for rotating the head portion 111 around a rotation axis extending in the Z-axis direction. The actuator 142 includes, for example, a stepping motor.

The speaker 143 emits sound in accordance with the control by the control circuit 170. For example, in the case where the power supply 200 detects an abnormality, the speaker 143 outputs a sound for notification an abnormality has been detected, in accordance with an audio signal supplied from control circuit 170. The abnormality includes an excessive temperature increase due to a foreign matter including metal or misalignment, a decrease in transmission efficiency due to misalignment, and the like.

The magnetic sensor 150 is a sensor that detects magnetism. The magnetic sensor 150 performs detection of magnetism generated by the magnet 250 provided in a predetermined part of the power supply 200. The magnetic sensor 150 outputs a voltage signal indicating a result of the detection of magnetism. For example, the magnetic sensor 150 outputs a voltage signal including a first voltage in the case where magnetism is not detected, and outputs a voltage signal including a second voltage in the case where magnetism is detected. The voltage signal output by the magnetic sensor 150 is supplied to the control circuit 170. The magnetic sensor 150 is positioned and angled to avoid detecting the magnetism generated by the power transmission coil 230.

The power receiving circuit 160 is a circuit that receives power wirelessly through the power receiving coil 130. The power receiving circuit 160 supplies, to the charging circuit 162, direct current power based on the alternating current power supplied from the power supply 200 through the power receiving coil 130. The power receiving circuit 160 operates in accordance with the control by the control circuit 170. The power receiving circuit 160 communicates with the power transmission circuit 260. For example, the power receiving circuit 160 sends a power supply request to the power transmission circuit 260 to receive power from the power transmission circuit 260. The power receiving circuit 160 includes a power receiving integrated circuit (IC) 161. The power receiving IC 161 converts alternating current power generated by the electromotive force induced by the power receiving coil 130 into direct current power, and supplies the direct current power to the charging circuit 162. The charging circuit 162 is a circuit for charging the battery 180. The charging circuit 162 charges the battery 180 with the power supplied from the power receiving circuit 160. The charging circuit 162 operates in accordance with the control by the control circuit 170. The charging circuit 162 includes a charging IC 163. The charging IC 163 charges the battery 180 with the power supplied from the power receiving IC 161.

The control circuit 170 controls the overall operation of the electronic device 100. For example, the control circuit 170 operates the electronic device 100 by operating the actuator 142 based on a result of the detection made by the sensor 141. Also, in the case where the control circuit 170 receives a notification from the power supply 200 that an abnormality has been detected, the control circuit 170 controls the speaker 143 to notify the user that an abnormality has been detected. The control circuit 170 includes a central processing unit (CPU), a read-only memory (ROM), a random access memory (RAM), a real-time clock (RTC), a flash memory, and the like. The CPU is also called a central processing unit, central arithmetic unit, a processor, a microprocessor, a microcomputer, a digital signal processor (DSP), or the like, and functions as a central arithmetic processor that executes processing and operation relating to control of the control circuit 170. The CPU in the control circuit 170 reads out a program and data stored in the ROM, flash memory, or the like, and integrally controls the control circuit 170 by using the RAM as a work area. The RTC is, for example, an integrated circuit having a clocking function. The CPU is capable of specifying a current date and time from time information read out from the RTC.

The battery 180 is a secondary battery capable of charging and discharging. The battery 180 is a power source of the electronic device 100. In other words, the battery 180 supplies power to the sensor 141, the actuator 142, the magnetic sensor 150, the power receiving circuit 160, the charging circuit 162, the control circuit 170, and the like. The battery 180 is charged by the power supplied from the power receiving circuit 160. The battery 180 includes, for example, a lithium ion battery.

The power transmission coil 230 is a coil that is to couple with the power receiving coil 130 and is used to supply power wirelessly. The power transmission coil 230 induces a magnetic flux with a varying magnitude in response to flowing of an alternating current. The power transmission coil 230 is a wire wound around an axis extending in the Z-axis direction. The power transmission coil 230 is disposed in a predetermined position within the power supply 200 such that the power transmission coil 230 faces the power receiving coil 130 in the housed state. In the housed state, the central axis of the power receiving coil 130 and the central axis of the power transmission coil 230 are close to each other.

The temperature sensor 240 detects a temperature around the power transmission coil 230. For example, the temperature sensor 240 detects a temperature of a non-illustrated thermal conduction member disposed below the power transmission coil 230. In the case where there is a foreign object including metal around the power transmission coil 230, the change in magnetic flux induced by the power transmission coil 230 causes eddy currents to flow within the foreign object, causing the foreign object to generate heat. The temperature sensor 240 is mainly used to detect the heat generation of the foreign object. The temperature sensor 240 supplies, to the control circuit 270, temperature information indicating a result of the detection of the temperature. The temperature sensor 240 is a contact-type temperature sensor, such as a resistance temperature detector, a linear resistor, and a thermistor.

The magnet 250 is an object that generates magnetism. The magnet 250 has two poles, an N pole and an S pole, and is an object that is a source of a bipolar magnetic field. The magnet 250 is arranged in the protrusion 213 in the power supply 200 to indicate that the power supply 200 is a suitable power supply for supplying power to the electronic device 100. The magnet 250 is disposed at a position and an angle corresponding to the position and angle of the magnetic sensor 150. In other words, the magnet 250 is positioned and angled to enable detection by the magnetic sensor 150 of the magnetism generated by the magnet 250 in the housed state. In the present embodiment, the magnet 250 is a permanent magnet.

The power transmission circuit 260 is a circuit for supplying power to the electronic device 100. The power transmission circuit 260 is a circuit for wirelessly supplying power through the power transmission coil 230. The power transmission circuit 260 supplies, to the power transmission coil 230, alternating current power based on the direct current power supplied from the power supply circuit 280. The power transmission circuit 260 operates in accordance with the control by the control circuit 270. The power transmission circuit 260 communicates with the power receiving circuit 160. Specifically, in the case where the power supply request is received from the power receiving circuit 160, the power transmission circuit 260 starts supplying power to the power receiving circuit 160. The power transmission circuit 260 includes a power transmission IC 261. The power transmission IC 261 converts the direct current power generated by the power supply circuit 280 into alternating current power and supplies the alternating current power to the power transmission coil 230.

The control circuit 270 controls the overall operation of the power supply 200. For example, the control circuit 270 controls the power transmission circuit 260 to supply power to the electronic device 100. The control circuit 270 controls supply of power to the electronic device 100 based on the result of the detection by the temperature sensor 240. For example, the control circuit 270 suspends supply of power to the electronic device 100 in response to a temperature at or above a suspension temperature being detected, and restarts supply of power to the electronic device 100 in response to a temperature at or below a restart temperature being detected. In the case where an abnormality has been detected, the control circuit 270 may notify the electronic device 100 that an abnormality has been detected, prompting the electronic device 100 to notify that an abnormality is occurring. The control circuit 270 includes a CPU, a ROM, a RAM, an RTC, a flash memory, and the like.

The power supply circuit 280 generates various types of power supply voltages to be used by the power supply 200. For example, the power supply circuit 280 steps down or steps up the direct current voltage supplied from an AC adapter 290 to generate the power supply voltages for the various components of the power supply 200. The AC adapter 290 is a device for converting alternating current power into direct current power. In the present embodiment, the AC adapter 290 converts the alternating current power supplied from the commercial power supply into direct current power, and supplies the direct current power to the power supply circuit 280. The AC adapter 290 includes a DC plug 291 to be connected to the power supply circuit 280.

Next, characteristic functions of the power transmission system 1000 is described while focusing on the functions of the control circuit 170. The power transmission circuit 260 supplies power to the electronic device 100. The protrusion 213 is given a feature of generating magnetism. The protrusion 213 is an example of a predetermined part. The feature of generating magnetism is an example of a predetermined feature.

The power receiving circuit 160 receives power from the power supply. The actuator 142 actuates the head portion 111 in accordance with the control by the control circuit 170. The actuator 142 is an example of an actuation member. The head portion 111 is an example of a movable portion.

The magnetic sensor 150 is a sensor for detecting placement of the electronic device 100 in a power-receivable position that is a position where power from the power supply 200 is receivable. The magnetic sensor 150 detects placement of the electronic device 100 in the power-receivable position by detecting the predetermined feature given to the predetermined part of the power supply 200. In the present embodiment, the predetermined feature is a feature of generating magnetism. The magnetic sensor 150 is a magnetic sensor that detects magnetism generated by the magnet 250 provided in the predetermined part.

The control circuit 170 controls the actuator 142 such that a predetermined motion is performed due to the activation of the head portion 111. This allows the robot (electronic device 100) to express, in a simulated manner, the behaviors performed by animals. Here, in the case where magnetism is not detected by the magnetic sensor 150, that is, in response to not detecting placement of the electronic device 100 in the power-receivable position, the control circuit 170 controls the actuator 142 such that a first motion is performed in which a magnitude of the movement is a first magnitude. This allows the robot (electronic device 100) to express, in a simulated manner, a first behavior performed by animals in which a magnitude of behavior is a first magnitude. Here, in the case where magnetism is detected by the magnetic sensor 150, that is, in response to detecting placement of the electronic device 100 in the power-receivable position, the control circuit 170 controls the actuator 142 such that the first motion is not performed.

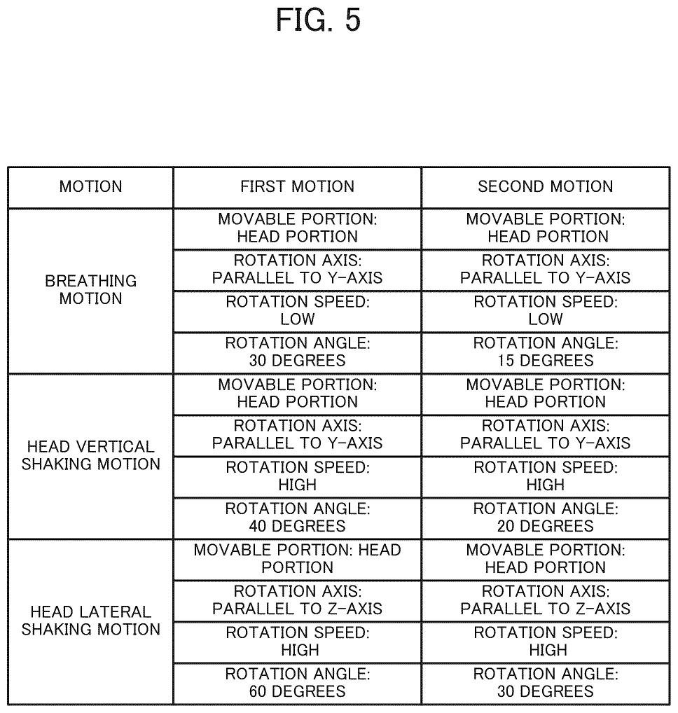

Additionally, in the present embodiment, in response to detecting placement of the electronic device 100 in the power-receivable position, the control circuit 170 controls the actuator 142 such that a second motion is performed in which a magnitude of movement is a second magnitude. This allows the robot (electronic device 100) to express, in a simulated manner, a second behavior performed by animals in which a magnitude of behavior is a second magnitude. The second magnitude is smaller than the first magnitude. In other words, the second motion is a motion that is smaller in movement than the first motion (the second behavior is a behavior that is smaller in movement than the first behavior). As described above, in the case where the electronic device 100 is placed in the power-receivable position, the control circuit 170 prevents the first motion that is larger in movement than the second motion, to thereby suppress misalignment of the electronic device 100. In other words, in the present embodiment, for causing the robot (the electronic device 100) to simulate behaviors performed by animals, the robot is caused to express the second behavior instead of the first behavior in response to detection of placement of the robot (electronic device 100) in the power-receivable position. The “placement of the electronic device 100 in the power-receivable position” corresponds to the state in which the electronic device 100 is housed in the housing 210 of the power supply 200. Hereinafter, each motion performed by the electronic device 100 (each behavior to be expressed by the robot) is described with reference to FIG. 5. The motions performed by the electronic device 100 include a breathing motion, a head vertical shaking motion, a head lateral shaking motion, and the like.

The breathing motion is a motion for expressing breathing of animals. The breathing motion is continuously performed while the power of the electronic device 100 is turned on. For example, the breathing motion is a motion of slowly rotating the head portion 111 around a rotation axis parallel to the Y-axis such that the head portion 111 moves slowly back and forth within a predetermined angular range. In the breathing motion, the movable portion is the head portion 111, the rotation axis is parallel to the Y-axis, and a rotation speed is slow. The first breathing motion that is the breathing motion corresponding to the first motion is different, in a rotation angle, from the second breathing motion that is the breathing motion corresponding to the second motion.

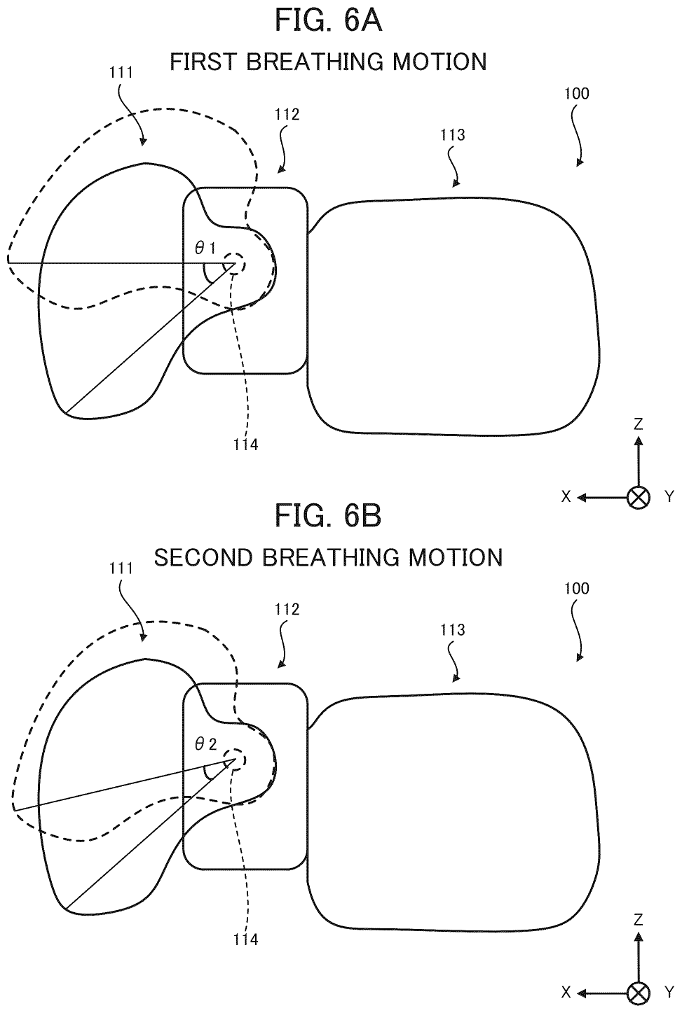

As illustrated in FIGS. 6A and 6B, the breathing motion is a motion of rotating the head portion 111 around a rotation axis 114 that is parallel to the Y-axis. As illustrated in FIG. 6A, in the first breathing motion, the rotation angle for rotation of the head portion 111 from a state in which the head portion 111 is positioned at the lowest position to a state in which the head portion 111 is positioned at the highest position is θ1. As illustrated in FIG. 6B, in the second breathing motion, the rotation angle for rotation of the head portion 111 from a state in which the head portion 111 is positioned at the lowest position to a state in which the head portion 111 is positioned at the highest position is θ1 that is smaller than θ1. In the present embodiment, θ1 is 30 degrees and θ2 is 15 degrees. Thus, the first breathing motion is larger in movement of the movable portion than the second breathing motion.

The head vertical shaking motion is a motion for expressing shaking of a head in the vertical direction. The head vertical shaking motion is performed, for example, in the case where a determination is made that an affirmative response is to be issued in response to a call from the user. For example, the head vertical shaking motion is a motion of quickly rotating the head portion 111 around the rotation axis parallel to the Y-axis such that the head portion 111 moves quickly back and forth within a predetermined angular range. In the head vertical shaking motion, the movable portion is the head portion 111, the rotation axis is parallel to the Y-axis, and the rotation speed is quick. A first head vertical shaking motion that is the head vertical shaking motion corresponding to the first motion is different, in the rotation angle, from a second head vertical shaking motion that is the breathing motion corresponding to the second motion. For example, the rotation angle in the first head vertical shaking motion is 40 degrees, and the rotation angle in the second head vertical shaking motion is 20 degrees.

The head lateral shaking motion is a motion for expressing shaking of a head in the lateral direction. The head lateral shaking motion is performed, for example, in the case where a determination is made that a negative response is to be issued in response to a call from the user. For example, the head lateral shaking motion is a motion of quickly rotating the head portion 111 around the rotation axis parallel to the Z-axis such that the head portion 111 moves quickly back and forth within a predetermined angular range. In the head lateral shaking motion, the movable portion is the head portion 111, the rotation axis is parallel to the Z-axis, and the rotation speed is quick. A first head lateral shaking motion that is the head lateral shaking motion corresponding to the first motion is different, in the rotation angle, from a second head lateral shaking motion that is the head lateral shaking motion corresponding to the second motion. For example, the rotation angle in the first head lateral shaking motion is 60 degrees, and the rotation angle in the second head lateral shaking motion is 30 degrees.

In the present embodiment, the electronic device 100 is a robot that includes the head portion 111 representing a head, the joint 112 for connecting the head portion 111 to the body portion 113, and a body portion 113 representing a body. The magnetic sensor 150 is provided in the body portion 113, not in the head portion 111 that is the movable portion. Due to this, the magnetic sensor 150 is less likely to be affected by the first motion, the second motion, and the like, and thus can perform stable magnetism detection.

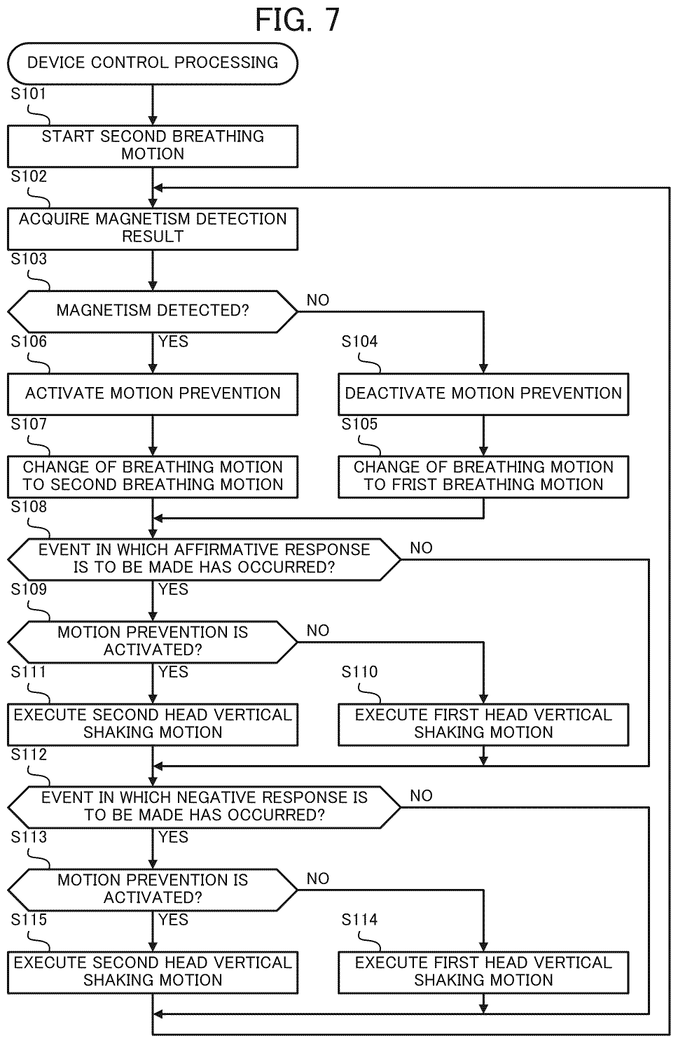

Next, device control processing executed by the electronic device 100 is described with reference to FIG. 7. The device control processing is started after the power of the electronic device 100 is turned on. First, the control circuit 170 included in the electronic device 100 starts the second breathing motion (step S101). For example, the control circuit 170 controls the actuator 142 to perform the second breathing motion simulating the breathing motion with a small movement. After completion of the processing in step S101, the control circuit 170 acquires a result of the detection of magnetism (step S102). For example, the control circuit 170 receives, from the magnetic sensor 150, the voltage signal indicating a result of the detection of magnetism, and acquires the result of the detection of magnetism indicated by the voltage signal. After completing the processing in step S102, the control circuit 170 determines whether magnetism has been detected (step S103). For example, in the case where a voltage indicated by the voltage signal is the second voltage, the control circuit 170 determines that magnetism has been detected. The phrase “magnetism has been detected” means that the device is in the housed state and that the electronic device 100 is placed in the power-receivable position.

Upon determining that magnetism is not detected (No in step S103), the control circuit 170 deactivates motion prevention (step S104). For example, the control circuit 170 updates motion prevention information stored in the flash memory included in the control circuit 170 so as to indicate that the motion prevention is not activated. In the case where the motion prevention has already been deactivated, the control circuit 170 does not execute any special processing. After completion of the processing in step S104, the control circuit 170 changes the breathing motion to the first breathing motion (step S105). For example, in the case where the breathing motion being performed is the second breathing motion, the control circuit 170 switches the breathing motion being performed from the second breathing motion to the first breathing motion. In the case where the breathing motion being performed is the first breathing motion, the control circuit 170 does not execute any special processing.

Upon determining that magnetism has been detected (YES in step S103), the control circuit 170 activates motion prevention (step S106). For example, the control circuit 170 updates the motion prevention information stored in the flash memory included in the control circuit 170 so as to indicate that the motion prevention is activated. In the case where the motion prevention has already been activated, the control circuit 170 does not execute any special processing. After completion of the processing in step S106, the control circuit 170 changes the breathing motion to the second breathing motion (step S107). For example, in the case where the breathing motion being performed is the first breathing motion, the control circuit 170 switches the breathing motion being performed from the first breathing motion to the second breathing motion, to reduce the rotation angle of the breathing motion. In the case where the breathing motion being performed is the second breathing motion, the control circuit 170 does not execute any special processing.

After completion of the processing in step S105 or step S107, the control circuit 170 determines whether an event has occurred in which an affirmative response is to be made (step S108). The event in which an affirmative response is to be made is an event in which a head is to be shaken in the vertical direction. For example, the control circuit 170 determines whether a voice of the user indicating affirmable content is detected by the sound sensor. For example, a case is assumed in which low remaining charge in the battery 180 corresponds to hungry, and high remaining charge corresponds to full. In this case, in response to detection of a voice of the user “Are you hungry? ” with low remaining charge of the battery 180, a determination is made that an event in which an affirmative response is to be made has occurred.

Upon determining that an event in which an affirmative response is to be made has occurred (YES in step S108), the control circuit 170 determines whether the motion prevention is activated (step S109). For example, the control circuit 170 determines, with reference to the motion prevention information stored in the flash memory, whether the motion prevention is activated. Upon determining that the motion prevention is not activated (NO in step S109), the control circuit 170 executes the first head vertical shaking motion (step S110). That is, the control circuit 170 controls the actuator 142 to thereby execute the first head vertical shaking motion simulating a large-magnitude head shaking in the vertical direction.

Upon determining that the motion prevention is activated (YES in step S109), the control circuit 170 executes the second head vertical shaking motion (step S111). That is, the control circuit 170 controls the actuator 142 to thereby execute the second head vertical shaking motion simulating a small-magnitude head shaking in the vertical direction. In the case of determining that an event in which an affirmative response is to be made has not occurred (NO in step S108), or after completion of the processing in step S110 or step S111, the control circuit 170 determines whether an event in which a negative response is to be made has occurred (step S112). The event in which a negative response is to be made is an event in which a head is to be shaken in the lateral direction. For example, in the aforementioned case, in response to detection of a voice of the user “Are you hungry? ” with high remaining charge of the battery 180, a determination is made that an event in which a negative response is to be made has occurred.

Upon determining that an event in which a negative response is to be made has occurred (YES in step S112), the control circuit 170 determines whether the motion prevention is activated (step S113). Upon determining that the motion prevention is not activated (NO in step S113), the control circuit 170 executes the first head lateral shaking motion (step S114). That is, the control circuit 170 controls the actuator 142 to thereby execute the first head lateral shaking motion simulating a large-magnitude head shaking in the lateral direction.

Upon determining that the motion prevention is activated (YES in step S113), the control circuit 170 executes the second head lateral shaking motion (step S115). That is, the control circuit 170 controls the actuator 142 to thereby execute the second head lateral shaking motion simulating a small-magnitude head shaking in the lateral direction. In the case of determining that an event in which a negative response is to be made has not occurred (NO in step S112), or after completion of the processing in step S114 or step S115, the control circuit 170 returns the processing to step S102.

According to the present embodiment, in response to not detecting placement of the electronic device 100 in the power-receivable position, the actuator 142 is controlled such that the first motion is performed, and in response to detecting placement of the electronic device 100 in the power-receivable position, the actuator 142 is controlled such that the first motion is not performed. Non-performance of the first motion with a large movement causes misalignment of the electronic device 100 to be less likely to occur. Therefore, the present embodiment can achieve suppressing misalignment of the electronic device 100 to thereby achieve proper supply of power. Note that, according to the present embodiment, even in the case where the electronic device 100 is placed in the power-receivable position without supply of power to the electronic device 100, the first motion is prevented to suppress misalignment of the electronic device 100.

Furthermore, in the present embodiment, in response to detecting placement of the electronic device 100 in the power-receivable position, the actuator 142 is controlled such that the second motion that is smaller in movement of the movable portion than the first motion is performed. Therefore, the present embodiment enables suppressing misalignment of the electronic device 100 without complete stoppage of the motion of the electronic device 100.

Furthermore, in the present embodiment, the electronic device 100 is a robot, the first motion is the first breathing motion for expressing breathing, and the second motion the second breathing motion for expressing breathing motion smaller than that of the first breathing motion. The present embodiment enables suppressing misalignment of the electronic device 100 without complete stoppage of the breathing motion of the electronic device 100 that is a robot.

Furthermore, in the present embodiment, the movable portion is the head portion 111, and the magnetic sensor 150 is provided in the body portion 113. The present embodiment enables reducing affecting the magnetic sensor 150 with movement of the movable portion.

Furthermore, in the present embodiment, placement of the electronic device 100 in the power-receivable position is detected by detecting the predetermined feature given to the predetermined part of the power supply 200. The present embodiment enables easily detecting placement of the electronic device 100 in the power-receivable position.

Furthermore, in the present embodiment, the predetermined feature given to the predetermined part is the feature of generating magnetism, and the magnetic sensor 150 detects magnetism generated by the magnet 250 provided in the predetermined part. The present embodiment enables, through detection of magnetism, easily detecting placement of the electronic device 100 in the power-receivable position.

In Embodiment 1, an example is described in which the predetermined feature given to the predetermined part is the feature of generating magnetism. In Embodiment 2, an example is described in which the predetermined feature given to the predetermined part is a feature of having a predetermined color. Similar configurations and functions to those of Embodiment 1 are appropriately omitted or simplified.

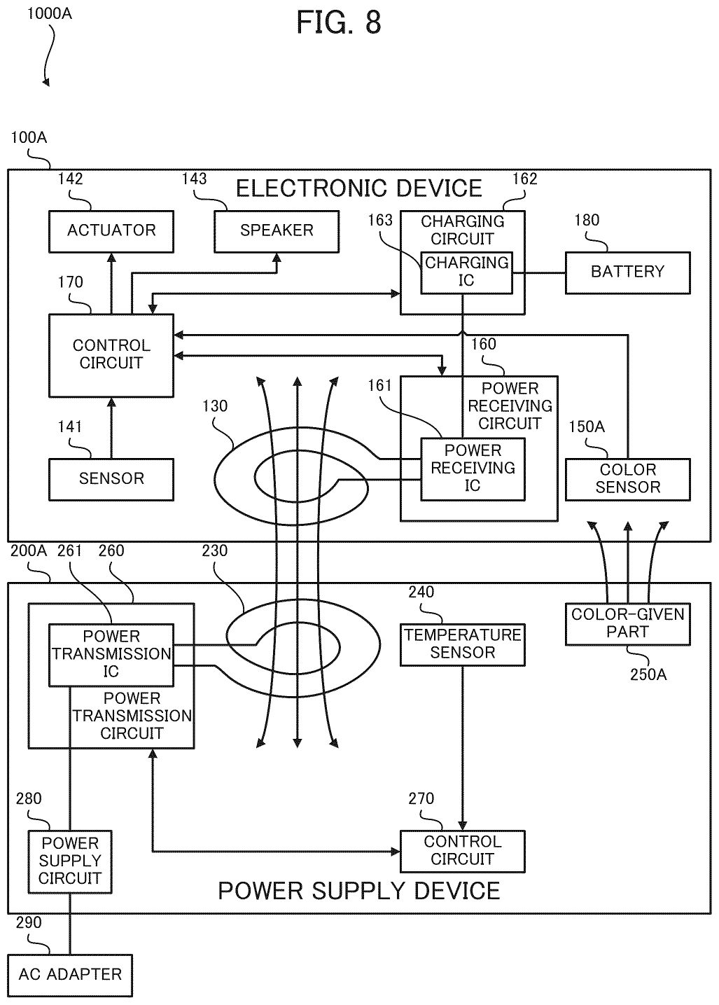

The power transmission system 1000A illustrated in FIG. 8 includes an electronic device 100A and a power supply 200A. The electronic device 100A includes the power receiving coil 130, the sensor 141, the actuator 142, the speaker 143, a color sensor 150A, the power receiving circuit 160, the charging circuit 162, the control circuit 170, and the battery 180. The power supply 200A includes the power transmission coil 230, the temperature sensor 240, a color-given part 250A, the power transmission circuit 260, the control circuit 270, and the power supply circuit 280.

The color sensor 150A is a sensor that detects a color of the color-given part 250A that is the predetermined part of the power supply 200A. The color sensor 150A includes a light-emitting part that emits light toward the color-given part 250A and a light-receiving part that receives light reflected by the color-given part 250A. The light-emitting part includes a light-emitting diode that emits white light. The light-receiving part includes photodiodes that receive red light, blue light, and green light. The color sensor 150A outputs a signal indicating the detected color. For example, the color sensor 150A outputs a voltage signal indicating intensity of red light, a voltage signal indicating intensity of blue light, and a voltage signal indicating intensity of green light.

The control circuit 170 identifies the color detected by the color sensor 150A, based on the voltage signals that are output by the color sensor 150A and that each indicate the intensity of light of the corresponding color. The control circuit 170 determines whether the color detected by the color sensor 150A matches a predetermined color. Predetermined color information indicating the predetermined color is stored in, for example, the flash memory included in the control circuit 170. In the case of determining that the color detected by the color sensor 150A matches the predetermined color, the control circuit 170 prevents the first motion and causes the second motion that is smaller in movement than the first motion to be performed. In the case of determining that the color detected by the color sensor 150A does not match the predetermined color, the control circuit 170 does not prevent the first motion and causes the first motion to be performed. The “match” of the color detected by the color sensor 150A and the predetermined color corresponds to placement of the electronic device 100A in the power-receivable position.

The color-given part 250A is the predetermined part of the power supply 200A having a predetermined color. The predetermined color indicates that the power supply 200A is a suitable power supply for supplying power to the electronic device 100A. The predetermined color may be any color. The color-given part 250A is a part that can be detected by the color sensor 150A in the housed state. For example, in the case where the color sensor 150A is arranged in the same position as the magnetic sensor 150 in Embodiment 1, the color-given part 250A may be the protrusion 213. The electronic device 100A and the power supply 200A are formed such that there are no obstacles between the color sensor 150A and the color-given part 250A. In the present embodiment, the predetermined feature given to the predetermined part is the feature of having the predetermined color, and the color sensor 150A detects the color of the predetermined part. The present embodiment enables, through detection of color, easily detecting placement of the electronic device 100A in the power-receivable position.

Although the embodiments are described above, the embodiments may be modified or applied in various manners. Any part of the configurations, functions, and operations described in the above embodiments may be employed. Furthermore, besides the configurations, functions, and operations described above, additional configurations, functions, and operations may be employed. Furthermore, the configurations, functions, and operations described in the above embodiments can be freely combined. In Embodiment 1, an example is described in which the movable portion is the head portion 111. The movable portion may be other than the head portion 111. For example, the movable portion may be the head portion 111 and the joint 112, or may be the body portion 113.

In Embodiment 1, an example is described in which motions including the first motion and the second motion are the breathing motion, the head vertical shaking motion, the head lateral shaking motion, and the like. The motions including the first motion and the second motion may be other motions. For example, the first motion may be a motion with a large oscillation and the second motion may be a motion with a small oscillation. As another example, the first motion may be a motion with an oscillation and the second motion may be omitted.

In Embodiment 1, an example is described in which the motions are achieved by rotation of the movable portion and the magnitude of the movement of the movable portion corresponds to the rotation angle. The configuration may be employed in which the motions are achieved by movement of the movable portion and a magnitude of the movement of the movable portion corresponds to an amount of movement.

In Embodiment 1, an example is described in which, in the case where magnetism is detected, the first motion is prevented and the second motion is performed. The configuration may be employed in which not only the first motion but also the second motion is prevented in the case where magnetism is detected. With this configuration, misalignment of the electronic device 100 can be further suppressed.

In Embodiment 1, an example is described in which the electronic device 100 is a robot designed to resemble and simulate a small animal. The electronic device 100 may be other robots or non-robot devices. For example, the electronic device 100 may be a smartphone, an electronic dictionary, a game device, or the like.

In Embodiment 1, an example is described in which the electronic device 100 is supplied power wirelessly. The electronic device 100 is not limited to a device that is supplied power wirelessly. For example, the electronic device 100 may be a device that is supplied power thorough electrodes. With this configuration, motion prevention of the electronic device 100 enables suppressing misalignment of the electrodes of the electronic device 100 from the power-receivable position. The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An electronic device, comprising:
an actuation member configured to actuate a movable portion;
a sensor configured to detect placement of the electronic device in a power-receivable position that is a position where power supplied from a power supply is receivable; and
at least one processor configured to control the actuation member such that a predetermined motion is performed due to the activation of the movable portion, wherein the at least one processor is configured to
in response to not detecting by the sensor the placement of the electronic device in the power-receivable position, control the actuation member such that a first motion is performed as the predetermined motion, and
in response to detecting by the sensor the placement of the electronic device in the power-receivable position, control the actuation member such that the first motion is not performed as the predetermined motion.

2. The electronic device according to claim 1, wherein
in response to detecting by the sensor the placement of the electronic device in the power-receivable position, the at least one processor controls the actuation member such that a second motion that is smaller in movement of the movable portion than the first motion is performed as the predetermined motion.

3. The electronic device according to claim 2, wherein
the electronic device is a robot,
the electronic device includes
a head portion representing a head,
a body portion representing a body, and
a joint for connecting the head portion and the body portion,
the movable portion is the head portion, and
the sensor is provided in the body portion.

4. The electronic device according to claim 2, wherein
the sensor detects the placement of the electronic device in the power-receivable position by detecting a predetermined feature given to a predetermined part of the power supply.

5. The electronic device according to claim 4, wherein
the predetermined feature is a feature of generating magnetism, and
the sensor detects magnetism generated by a magnet provided in the predetermined part.

6. The electronic device according to claim 3, wherein
a power receiving coil for wirelessly receiving power from the power supply is provided in the body portion.

7. The electronic device according to claim 2, wherein
the electronic device is a robot designed to resemble and simulate an animal, and
the predetermined motion is a motion for causing the robot to express, in a simulated manner, a breathing motion of the animal.

8. The electronic device according to claim 7, further comprising:
a head portion representing a head, wherein
the first motion is a motion of moving the head portion back and forth within a predetermined angular range, and
the second motion is a motion of moving the head portion back and forth within an angular range that is smaller than the predetermined angular range.

9. A control method, comprising:
executing processing of
detecting, by a sensor, placement of an electronic device including an actuation member for actuating a movable portion in a power-receivable position that is a position where power supplied from a power supply is receivable, and
controlling the actuation member such that a predetermined motion is performed due to the activation of the movable portion, wherein
the processing includes
in response to not detecting by the sensor the placement of the electronic device in the power-receivable position, controlling the actuation member such that a first motion is performed as the predetermined motion, and
in response to detecting by the sensor the placement of the electronic device in the power-receivable position, controlling the actuation member such that the first motion is not performed as the predetermined motion.

10. The control method according to claim 9, wherein
the processing includes
in response to detecting by the sensor the placement of the electronic device in the power-receivable position, controlling the actuation member such that a second motion that is smaller in movement of the movable portion than the first motion is performed as the predetermined motion.

11. The control method according to claim 10, wherein
the electronic device is a robot that includes a head portion representing a head, a body portion representing a body, and a joint for connecting the head portion and the body portion,
the movable portion is the head portion, and
the sensor is provided in the body portion.

12. The control method according to claim 11, wherein
a power receiving coil for wirelessly receiving power from the power supply is provided in the body portion.

13. The control method according to claim 10, wherein
the electronic device is a robot designed to resemble and simulate an animal, and
the predetermined motion is a motion for causing the robot to express, in a simulated manner, a breathing motion of the animal.

14. The control method according to claim 13, wherein
the electronic device includes a head portion representing a head of an animal,
the first motion is a motion of moving the head portion back and forth within a predetermined angular range, and
the second motion is a motion of moving the head portion back and forth within an angular range that is smaller than the predetermined angular range.

15. A non-transitory recording medium storing a program readable by a computer of an electronic device including an actuation member for actuating a movable portion, the program causing the computer to implement functions of:
detecting, by a sensor, placement of the electronic device in a power-receivable position that is a position where power supplied from a power supply is receivable, and
controlling the actuation member such that a predetermined motion is performed due to the activation of the movable portion, wherein
the functions include
in response to not detecting by the sensor the placement of the electronic device in the power-receivable position, controlling the actuation member such that a first motion is performed as the predetermined motion, and
in response to detecting by the sensor the placement of the electronic device in the power-receivable position, controlling the actuation member such that the first motion is not performed as the predetermined motion.

16. The non-transitory recording medium according to claim 15, wherein
the functions include
in response to detecting by the sensor the placement of the electronic device in the power-receivable position, controlling the actuation member such that a second motion that is smaller in movement of the movable portion than the first motion is performed as the predetermined motion.

17. The non-transitory recording medium according to claim 16, wherein
the electronic device is a robot that includes a head portion representing a head, a body portion representing a body, and a joint for connecting the head portion and the body portion,
the movable portion is the head portion, and
the sensor is provided in the body portion.

18. The non-transitory recording medium according to claim 17, wherein
a power receiving coil for wirelessly receiving power from the power supply is provided in the body portion.

19. The non-transitory recording medium according to claim 16, wherein
the electronic device is a robot designed to resemble and simulate an animal, and
the predetermined motion is a motion for causing the robot to express, in a simulated manner, a breathing motion of the animal.

20. The non-transitory recording medium according to claim 19, wherein
the electronic device includes a head portion representing a head of an animal,
the first motion is a motion of moving the head portion back and forth within a predetermined angular range, and
the second motion is a motion of moving the head portion back and forth within an angular range that is smaller than the predetermined angular range.
